(19) United States
(12) Patent Application Publication
(10) Pub. No.: US 2007/0129943 A1
(43) Pub. Date: Jun. 7, 2007

(54) Speech recognition using adaptation and prior knowledge

(75) Inventors: Xin Lei, Shoreline, WA (US); Jonathan E. Hamaker, Woodinville, WA (US); Xiaodong He, Issaquah, WA (US); Patrick Nguyen, Seattle, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/295,297

(22) Filed: Dec. 6, 2005

(51) Int. Cl. G10L 15/00

(52) U.S. Cl. 704/240

(57) ABSTRACT

A speech recognition system includes a feature extraction component that receives a speech signal and extracts feature vectors from the speech signal. Also included, is a decoder having a speech acoustic model, a feature modification component, and a comparison component. The feature modification component changes the feature vectors, using adaptation data and prior data, to more closely match. the speech acoustic model. The comparison component utilizes the modified feature vectors and the speech acoustic model to recognize the speech signal.

### BACKGROUND

In general, a speech recognition system includes certain primary components such as a front end that receives audio information (for example, speech into a microphone) and turns it into feature vectors (which are analyzable data), and a speech acoustic model that describes acoustic properties of speech. Most current speech recognition systems are capable of, at least to some extent, adapting to better reflect speech characteristics of a current user of the speech recognition system.

One adaptation method includes adjusting or modifying, in substantially real-time, the speech acoustic models themselves (model space adaptation). This involves changing one or more parameters of the model(s). Another adaptation method involves changing the feature stream to better resemble the speech acoustic model(s) included in the speech recognition. system (feature space adaptation). This can be viewed as changing the received audio to adapt to the model(s) rather than altering the model(s) to match the received audio.

A problem with many current speech recognition systems is that adaptation data is substantially limited. For example, in a telephony speech recognition system, a user might call in to the system and speak a few utterances. The speech recognition system would have a difficult time adapting itself based on the utterances, because they contain only a small amount of adaptation data. Thus, this type of adaptive speech recognition system tends to not be very robust.

The discussion above is merely provided for general background information and is not intended to be used as an aid in determining the scope of the claimed subject matter.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter

The present embodiments relate to a speech recognition method and system. Embodiments of the speech recognition system include a feature extraction component that receives a speech signal and extracts feature vectors from the speech signal. Also included, is a decoder having a speech acoustic model, a feature modification component, and a comparison component. The feature modification component changes the feature vectors, based on adaptation data (online data or data obtained by the speech recognition system after it has been deployed) and prior data (offline data or data obtained independently of the speech recognition system), to more closely match the speech detection model. The comparison component utilizes the modified feature vectors and the speech acoustic model to recognize the speech signal.

### BRIEF DESCRIPTION OF THE DRAWINGS

FIG. 1 is a block diagram of one illustrative computing environment in which the present embodiments can be implemented.

FIG. 2 is a block diagram of one illustrative speech recognition system in which the present embodiments can be used.

FIG. 3 is a flowchart that illustrates one of the present embodiments.

### DETAILED DESCRIPTION

The present embodiments deal with recognizing speech signals. However, before describing the present embodiments in greater detail, one illustrative environment in which the present embodiments can be used will be described.

Exemplary Computing Environment

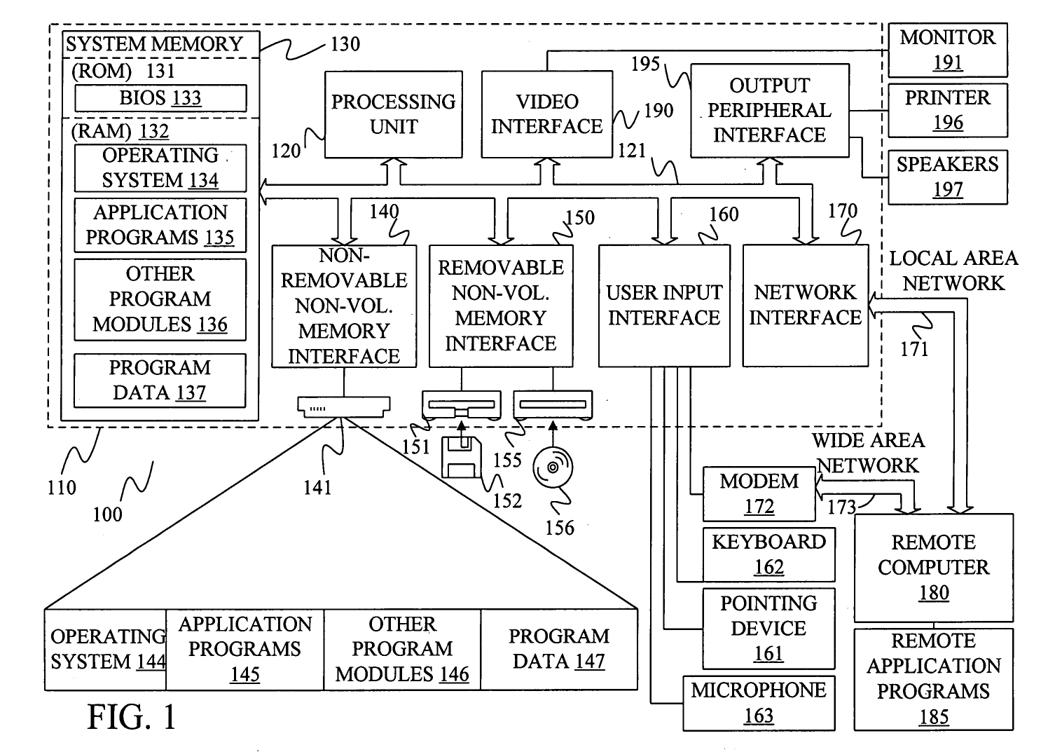

FIG. 1 illustrates an example of a suitable computing system environment 100 on which the present embodiments may be implemented. The computing system environment 100 is only one example of a suitable computing environment and is not intended to suggest any limitation as to the scope of use or functionality of the present embodiments. Neither should the computing environment 100 be interpreted as having any dependency or requirement relating to any one or combination of components illustrated in the exemplary operating environment 100.

The embodiments are operational with numerous other general purpose or special purpose computing system environments or configurations. Examples of well-known computing systems, environments, and/or configurations that may be suitable for use with the present embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The present embodiments may be described in the general context of computer-executable instructions, such as program modules, being executed by a computer. Generally, program modules include routines, programs, objects, components, data structures, etc. that perform particular tasks or implement particular abstract data types. The embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the present embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data .137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163 (which can be either built into the computer or a separate device), a telephony board connected to a telephone line, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way. of example, and not limitation, FIG. 1 illustrates remote application programs 185 as residing on remote computer 180. It will be appreciated that the network connections shown are exemplary and other means of establishing a communications link between the computers may be used.

General Speech Recognition Embodiments

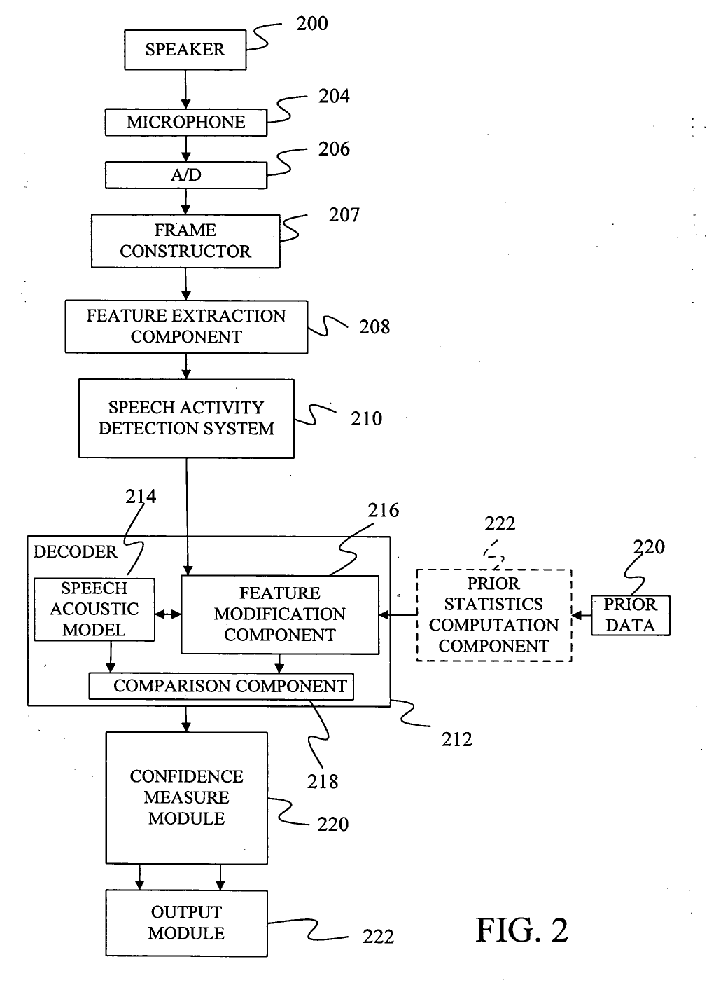

FIG. 2 provides a block diagram of an environment in which adaptation data and prior data can be utilized to help recognize a speech signal. In particular, FIG. 2 shows a speech recognition system having a decoder that includes a feature modification component that is capable of changing feature vectors, using adaptation data and prior statistics, to more closely match a speech detection model.

In FIG. 2, a speaker 200 speaks into a microphone 204. The audio signals detected by microphone 204 are converted into electrical signals that are provided to analog-to-digital (A-to-D) converter 206.

A-to-D converter 206 converts the analog signals from microphone 204 into a series of digital values. In several embodiments, A-to-D converter 206 samples the analog signal at 16 kHz and 16 bits per sample, thereby creating 32 kilobytes of speech data per second. Of course, other sampling can be used. These digital values are provided to a frame constructor 207, which, in one embodiment, groups the values into 25 millisecond frames that start 10 milliseconds apart.

The frames of data created by frame constructor 207 are provided to feature extraction component 208, which extracts a feature from each frame. Examples of feature extraction modules include modules for performing Linear Predictive Coding (LPC), LPC derived Cepstrum, Perceptive Linear Prediction (PLP), Auditory model feature extraction, and Mel-Frequency Cepstrum Coefficients (MFCC) feature extraction. Note that the embodiments are not limited to these feature extraction modules and that other suitable modules may be used.

The feature extraction module produces a stream of feature vectors that are each associated with a frame of the speech signal. This stream of feature vectors is provided to speech activity detection system 210, which detects whether a feature vector represents speech or non-speech (such as silence or noise). If system 210 decides that the feature vector represents speech, the feature vector is provided to decoder 212.

As can be seen in FIG. 2, decoder 212 includes a speech acoustic model 214, a feature modification component-216 and a comparison component 218. Feature modification component 216 changes the feature vectors, using adaptation data and prior data 220 (or prior statistics computed from the prior data by component 222), to more closely match speech acoustic model 214. It should be noted that, in some embodiments, prior statistics computation component 222 can be a part of feature modification component 216 within decoder 212. Comparison component 218-utilizes the modified feature vectors and speech acoustic model 214 to recognize the speech signal (that is, to identify a most likely sequence of words based on the stream of feature vectors).

The most probable sequence of hypothesis words is provided to a confidence measure module 220. Confidence measure module 220, in one illustrative embodiment, identifies which words are most likely to have been improperly identified by the decoder, based in part on a confidence measure model (not shown). Confidence measure module 220 then provides the sequence of hypothesis words to an output module 222 along with identifiers indicating which words may have been improperly identified. Those skilled in the art will recognize that confidence measure module 220 is not necessary for the practice of the present embodiments.

Although FIG. 2 depicts a speech recognition system, the present embodiments may be used in any pattern recognition system and is not necessarily limited to speech.

As described above in connection with FIG. 2, the present speech recognition embodiments, in general, utilize adaptation data and prior data to help recognize speech. The derivation and implementation of one such speech recognition embodiment is described in detail below. It should be noted that the speech recognition embodiment described below is only an example.

Derivation of a Specific Speech Adaptation Algorithm

As mentioned earlier, in certain speech recognition applications, such as telephony speech recognition, the data available for acoustic adaptation may be quite limited. Feature space maximum likelihood linear regression (fMLLR) is one speech recognition technique that has been implemented for acoustic adaptation in a telephony engine due to its relatively low cost. However, with very limited adaptation data (1-3 seconds of speech data, for example), the linear transform estimated by fMLLR-may not be very robust.

In the present example embodiment, feature space maximum a posteriori linear regression (fMAPLR) is used to incorporate prior knowledge for the feature transform estimation and improve the robustness of the fMLLR approach. As will be apparent from the description that follows, the fMAPLR solution is derived using elliptically symmetric matrix variate distributions as priors. fMAPLR is an improvement over fMLLR in the sense that it incorporates prior knowledge in the adaptation. When the adaptation data is very limited, the linear regression transform will be estimated more by the prior information. When the adaptation data volume increases, the effect of the prior knowledge will become smaller. Eventually, with a substantial amount of data, feature space MAPLR will converge to fMLLR. A derivation of the fMLLR algorithm is first included below to provide a better understanding of the subsequently included fMAPLR solution.

A. Feature Space Maximum Likelihood Linear Regression (fMLLR)

Let oₜ be an n-dimensional feature vector at time t in an original feature space; the corresponding transformed feature vector ôₜ is,
ôₜ=Aoₜ+b=Wξₜ, Equation (1)
where A is an nxn rotation matrix, b is an n×1 bias term, ξₜ=[1 oₜ^{T}]^{T} is an (n+1)×1 extended observation vector and W=[b A] is an n×(n+1) extended transformation matrix. The transform parameters are estimated by optimizing the following auxiliary Q-function,

$${Q}_{ML} = - \frac{1}{2} {\sum }_{t , m} {γ}_{m} ( t ) \{ log {\vert A \vert}^{2} + {( W {ξ}_{t} - {μ}^{( m )} )}^{T} {\sum }^{m - 1} ( W {ξ}_{t} - {μ}^{( m )} ) \} , \qquad Equation ( 2 )$$

where μ^{(m)} and Σ^{(m)} are a mean and a covariance for Gaussian component m and γₘ(t) is a posterior probability of being in Gaussian m at time t.

Because of the log determinant in the objective function in Equation 2, in general, there is no explicit closed-form solution for the transformation matrix W and therefore an iterative solution has been chosen. The covariance matrices are assumed to be diagonal: Σ^{(m)}=diag([1/σ₁^{(m)2}1/σ₂^{(m)2} . . . 1/σₙ^{(m)2}]). Let the i-th row of W be wᵢ=[Wᵢ₁Wᵢ₂ . . . Wᵢₙ]^{r}. Taking the derivative of Q_{ML} with respect to wᵢ and equating to zero, the following equation is obtained.

$$\frac{\partial {Q}_{ML}}{\partial {w}_{i}} = β \frac{{p}_{i}}{{p}_{i}^{T} {w}_{i}} - {G}^{( i )} {w}_{i} + {k}^{( i )} = 0 , \qquad Equation ( 3 )$$

where
is the total count, Pᵢ is the extended

$$β = {\sum }_{t , m} {γ}_{m} ( t )$$

cofactor vector [0cof(Aᵢ₁) . . . cof(Aᵢₙ)]^{r} and the sufficient statistics G⁽ⁱ⁾and k⁽ⁱ⁾ are as follows:

$$\begin{matrix}{G}^{( i )} = {\sum }_{t} {ξ}_{t} {ξ}_{t}^{T} {\sum }_{m} \frac{{γ}_{m} ( t )}{{σ}_{i}^{( m ) 2}} & Equation ( 4 ) \\ {k}^{( i )} = {\sum }_{t} {ξ}_{t} {\sum }_{m} \frac{{γ}_{m} ( t ) {μ}_{i}^{( m )}}{{σ}_{i}^{( m ) 2}} . & Equation ( 5 )\end{matrix}$$

Based on the foregoing, an iterative solution for the transform matrix W is
wᵢ=G⁽ⁱ⁾⁻¹(αpᵢ+k⁽ⁱ⁾), Equation (6)
where α is solved from the following quadratic equation and the root that maximizes the Q-function is selected.
α²pᵢ^{T}G⁽ⁱ⁾⁻¹pᵢ+αpᵢ^{T}G⁽ⁱ⁾⁻¹k⁽ⁱ⁾−β=0 Equation (7)
B. Feature Space Maximum a Posteriori Linear Regression (fMAPLR)

As noted earlier, in telephony applications, each phone call typically lasts for only a few utterances and the data available for adaptation is very limited (for example, 1-5 seconds of speech data). This may lead to unreliable fMLLR adaptation transforms due to overtraining. As noted above, in order to address this robustness issue, the maximum a posteriori framework is applied and fMAPLR based speaker adaptation is utilized.

An auxiliary Q-function for fMAPLR with prior matrix distribution of p(W) is given by
Q_{MAP}=Q_{ML}+log p(W), Equation (8)
It is assumed that the feature transformation matrix W follows an elliptically symmetric matrix variate distribution,

$$p ( W ) ∝ exp [ - \frac{1}{2} {\sum }_{i = 1}^{n} {( {w}_{i} - {M}_{i} )}^{T} {V}_{i}^{- 1} ( {w}_{i} - {M}_{i} ) ] , \qquad Equation ( 9 )$$

where Mₗ is the location parameter and Vᵢ is the scale parameter for wᵢ. Mᵢ and Vᵢ are called hyperparameters of the prior distribution.

Taking the derivative of Equation 8 and substituting in Equation 3 and Equation 9, the following equation is obtained.

$$\begin{matrix}\frac{\partial {Q}_{MAP}}{\partial {w}_{i}} = β \frac{{p}_{i}}{{p}_{i}^{T} {w}_{i}} - {\hat{G}}^{( i )} {w}_{i} + {\hat{k}}^{( i )} = 0 , \\ where & Equation ( 10 ) \\ {\hat{G}}^{( i )} = {G}^{( i )} + {V}_{i}^{- 1} & Equation ( 11 ) \\ {\hat{k}}^{( i )} = {k}^{( i )} + {V}_{i}^{- 1} {M}_{i} & Equation ( 12 )\end{matrix}$$

Equation 10 has the same form as Equation 3. Therefore, the fMAPLR transform can be estimated in the same iterative manner as in fMLLR, but with different statistics of Ĝ⁽ⁱ⁾ and \hat{k}⁽ⁱ⁾. These statistics are a smoothed version of the fMLLR statistics with the prior knowledge about the transform distribution incorporated.

Usually, as described earlier, the prior distribution is estimated from a large amount of offline data and therefore is reliable but less relevant to the current user. On the other hand, the adaptation data, which is produced by the current user, is more relevant but in a limited amount and therefore the statistics are less robust.

When the adaptation data amount is very small, Equation 11 of fMAPLR is dominated by the statistics from the prior distribution. When more adaptation data is available, Equation 11 converges to Equation 4 of fMLLR. In this manner, the fMAPLR provides robustness to small amounts of adaptation data.

C. Prior Distribution Hyperparameter Estimation

As mentioned above, Mᵢ and Vᵢ are called hyperparameters of the prior distribution. In a strict Bayesian approach, the hyperparameters are assumed known based on a common or subjective knowledge about the stochastic process. In most cases, it is difficult to obtain this common knowledge about the informative prior distribution. As a popular solution, the empirical Bayesian approach is widely used where the hyperparameters are learned from the data.

Assuming that there are K observations of the transformation matrices {W⁽ⁱ⁾, . . . W^{(k)}}, the hyper-parameters (hypermean Mᵢ and hypervariance Vᵢ) can be estimated by,

$$\begin{matrix}{M}_{i} = \frac{1}{K} {\sum }_{r = 1}^{K} {w}_{i}^{( r )} & Equation ( 13 ) \\ {V}_{i} = \frac{1}{K} {\sum }_{r = 1}^{K} ( {w}_{i}^{( r )} - {M}_{i} ) {( {w}_{i}^{( r )} - {M}_{i} )}^{T} & Equation ( 14 )\end{matrix}$$

where wᵢ^{(r)} is the i-th row of the matrix W^{r}.

In a specific embodiment, speech data from a disjoint development set is extracted and one fMLLR feature transform matrix is estimated for each speaker in the development set. Then, Equations 13 and 14 are utilized to estimate the prior distribution used in fMAPLR in future tests.

Description of System Flowchart for Specific Speech Recognition Embodiment

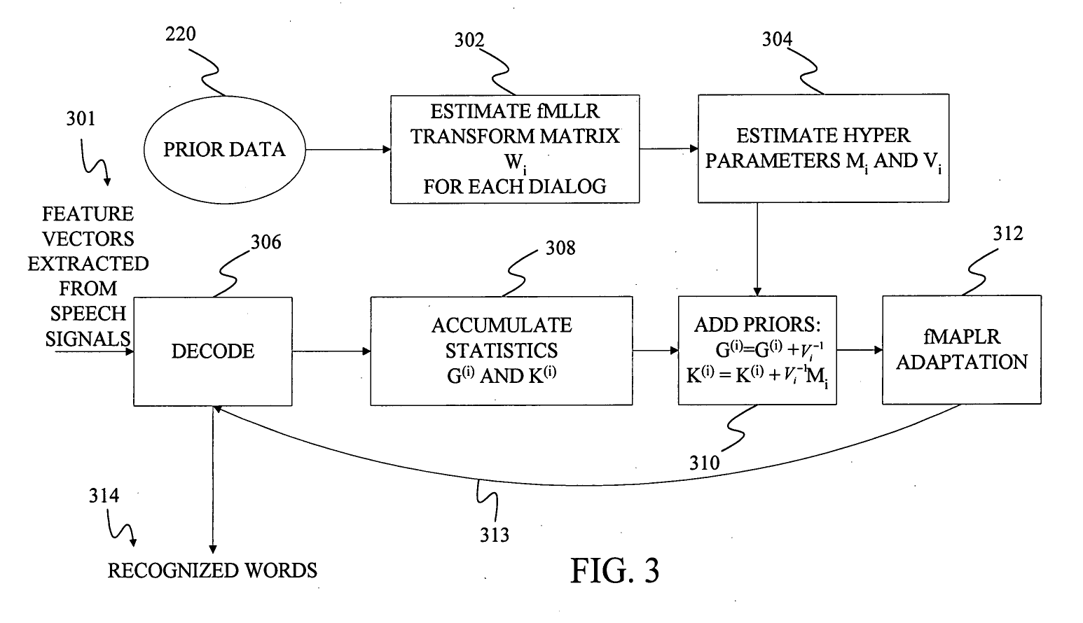

FIG. 3 is a system flowchart 300 for the above-described example embodiment. As step 302, one fMLLR feature transform matrix is estimated for each dialog in the development set or prior data 220. At step 304, hyperparameters are estimated (using Equations 13 and 14, for example). Steps 302 and 304 are usually carried out prior to deploying the speech recognition system. The remaining steps (306-312) of flowchart 300 are carried during operation of the speech recognition system. As newly received feature vectors (301) are decoded and recognized words (314) are output at step 306, adaptation data from an immediately previous iteration is accumulated with adaptation data from earlier iterations at step 308. At step 310, prior statistics are added to the adaptation data and, at step 312, the combined data is utilized for fMAPLR adaptation in a manner described earlier. In some embodiments (referred to as incremental mode embodiments), arrow 313 is. followed continuously after each utterance, whereas in other embodiments (referred to a batch mode embodiments) accumulation is carried out at step 308 for a predetermined period before prior statistics are added (step 310) and the feature transform is calculated (step 312) and applied to decode box 306 (indicated by arrow 313). Details regarding incremental and batch mode operation are provided further below in connection with a description of experiments that were carried out using the present embodiments. In some embodiments, all of steps 302-312 are performed by decoder 212 (FIG. 2). In other embodiments, only some of steps 302-312 may be carried out by decoder 212. In general, different techniques, some of which are set forth above, can be employed to carry out the steps shown in the flow chart of FIG. 3 while maintaining substantially the same functionality without department from the scope and spirit of the present embodiments.

Experiments

Experiments were conducted using two telephony speech recognition databases, designated herein as D1 and D2 respectively. Both test sets are United States English telephony databases over diverse topics such as digits, letters, names and dates and covering landline, speakerphone and cell phone conditions. In D1, the development set used for prior distribution estimation contains about 300 speakers, each of them provided about 45 seconds of speech data. The corresponding test set contains about 100 speakers. For simplicity, diagonal scale factor matrices, Vᵢ, were used in the prior distribution. In order to further verify the robustness of the proposed approach, the prior distributions derived from D1 are used to test fMAPLR on D2, which contains data in a very noisy environment. Test set D2 contains 82 dialogs, with around 19 utterances on average for each dialog. Each utterance typically contains around 1 second of speech data. A speaker independent, triphone-based acoustic model is used. Senone clustering is performed based on a phonetic decision tree and the model has about 50 K Gaussians.

Experiments were carried out with two different methods for organizing the adaptation data and applying the adapted transforms: batch mode and incremental mode. In batch adaptation mode, the first T frames of speech data. are used to derive the feature transformation matrix. The estimated feature transform is then applied to the remainder of the data in the dialog. In incremental adaptation mode, as in batch mode, the adaptation transform is estimated after T frames of data. However, in incremental mode, the adaptation transform is continuously updated and applied as new data is seen. In the incremental mode experiments, the new transform is applied and updated after each utterance in the dialog.

A. Batch Mode Experiments

Batch mode results for fMLLR and fMAPLR adaptation experiments on D1 and D2 are shown in Table 1 and Table 2 respectively. In Table 1, it is observed that for fMLLR, when only 100 frames of adaptation data are available, poor feature transforms are estimated causing a dramatic degradation. Even when the adaptation data amount increases to 300 frames per speaker, the fMLLR adaptation still did not perform as well as the baseline without adaptation for D1. On the other. hand, fMAPLR provides a much more stable result even at the extreme of only 100 frames of adaptation data. fMAPLR is able to achieve a 3.2% relative gain after estimating transforms from only 300 frames of data.

To test the robustness of fMAPLR and the generalization of the prior distribution estimation, the prior distribution estimated on D1 is applied to the fMAPLR estimation for the test set of D2. These results are shown in Table 2. The results show that fMAPLR is more robust than fMLLR even with the hyperparameters learned from a database with a mismatched environment. Also, a larger T will not necessarily lead to a lower overall word error rate (WER) since that reduces the amount of data to be decoded using speaker adapted system. This effect is more significant if the dialog provided by each speaker is very short. Of course, the system could be modified to re-decode the input after adaptation to regain some of this loss.

TABLE 1
WER on D1 test set in batch mode.

| | T = 100 | T = 300 |
|---|---|---|
| No adaptation | 11.33 | 11.33 |
| FMLLR | 21.55 | 11.84 |
| FMAPLR | 11.36 | 10.97 |

TABLE 2
WER on D2 test set in batch mode.

| | T = 100 | T = 300 |
|---|---|---|
| No adaptation | 14.27 | 14.27 |
| FMLLR | 18.09 | 13.52 |
| FMAPLR | 13.14 | 13.61 |

B. Incremental Mode Experiments

Incremental mode results for fMLLR and fMAPLR on D1 and D2 are shown in Table 3 and Table 4 respectively. As in batch mode, Table 3 shows that fMAPLR incremental adaptation performs better than the fMLLR adaptation. Unlike batch mode, fMLLR now gives some improvement over the baseline at T=100 case because the poor transform estimated from the first 100 frames of data has been corrected when more data are decoded and used for transform estimation. Table 4 shows incremental adaptation at different time delays. In this experiment T=0 indicates that the incremental adaptation is started as soon as the first utterance is decoded. The prior distribution estimated on D1 has generalized substantially well to D2. Moreover, fMAPLR performs consistently better than fMLLR, and it shows the best performance by conducting fMAPLR as soon as the first utterance is decoded and available for adaptation. This is critical for the applications such as name dialing, where the whole dialog contains only a few dialog turns.

TABLE 3
WER on D1 test set in incremental mode.

| | T = 100 | T = 300 |
|---|---|---|
| No adaptation | 11.33 | 11.33 |
| fMLLR | 10.86 | 10.51 |
| fMAPLR | 10.45 | 10.45 |

TABLE 4
WER on D2 test set in incremental mode.

| | T = 0 | T = 100 | T = 300 |
|---|---|---|---|
| No adaptation | 14.27 | 14.27 | 14.27 |
| fMLLR | 15.83 | 13.10 | 13.05 |
| fMAPLR | 12.71 | 12.81 | 12.95 |

The above experimental results for the example embodiment demonstrate that that fMAPLR, which is a Bayesian counterpart of fMLLR to estimate the feature transforms with prior knowledge and to learn the hyperparameters of the prior distribution, performs more robustly than fMLLR when the adaptation data is very limited. However, in general, utilizing adaptation data and prior data in a manner similar to that described in connection with any of the above general or specific embodiments helps provide relatively robust speech recognition. It should be noted that, although some of the earlier-discussed embodiments are primarily described as being utilized for speaker adaptation, in general, the present embodiments can also be used for channel (or environment) adaptation, dialect adaptation, pronunciation adaptation, language adaptation, etc. That is, any statistical portion of the system could be adapted in an analogous manner. As mentioned earlier, the speech recognition techniques of the present embodiments may be used in any pattern recognition systems and are not necessarily limited to speech.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A speech recognition system comprising:
a feature extraction component configured to receive a speech signal and to extract feature vectors from the speech signal; and
a decoder comprising a speech acoustic model, a feature modification component, and a comparison component,
wherein the feature modification component is configured to modify the feature vectors, using adaptation data and prior statistics, to more closely match the speech acoustic model, and wherein the comparison component is configured to utilize the modified feature vectors and the speech acoustic model to recognize the speech signal.

2. The system of claim 1 wherein the prior statistics are obtained from a statistical distribution and incorporated in a Bayesian framework.

3. The method of claim 3 wherein the statistical distribution is an elliptically symmetric matrix variate distribution.

4. The system of claim 1 wherein the feature modification component operates using Feature Space Maximum A Posteriori Linear Regression (fMAPLR) based adaptation.

5. The system of claim 4 wherein the feature modification component is configured to carry out the fMAPLR based adaptation in batch mode.

6. The system of claim 4 wherein the feature modification component is configured to carry out the fMAPLR based adaptation in incremental mode.

7. The system of claim 1 and further comprising a prior statistics computation component configured to receive prior data and to compute hyperparameters for the prior data, wherein the hyperparameters constitute the prior statistics.

8. The system of claim 7 wherein the prior data comprises telephony dialogs obtained independently of the speech recognition system.

9. The system of claim 8 wherein the prior statistics computation component is configured to generate feature transform matrices for the telephony dialogs and to compute the hyperparameters from the feature transform matrices.

10. A method of recognizing a speech signal using a speech acoustic model, the method comprising:
extracting feature vectors from the speech signal;
modifying the feature vectors using adaptation data and prior data to more closely match the speech acoustic model; and
utilizing the modified feature vectors and the speech acoustic model to recognize the speech signal.

11. The method of claim 10 wherein modifying the feature vectors using adaptation data and prior data comprises modifying the feature vectors using adaptation data and prior statistics, corresponding to the prior data, incorporated in a Bayesian framework.

12. The method of claim 11 wherein the prior statistics are obtained from a statistical distribution.

13. The method of claim 12 wherein the statistical distribution is an elliptically symmetric matrix variate distribution.

14. The method of claim 12 wherein the prior data comprises telephony dialogs obtained independently of the speech recognition system, and wherein the prior statistics are computed by:
generating feature transform matrices for the telephony dialogs; and
computing hyperparameters from the feature transform matrices.

15. The method of claim 1 wherein modifying the feature vectors using adaptation data and prior data to more closely match the speech recognition system is carried out using Feature Space Maximum A Posteriori Linear Regression (fMAPLR) based adaptation.

16. The method of claim 15 wherein the fMAPLR based adaptation is carried out in batch mode.

17. The method of claim 15 wherein the fMAPLR based adaptation is carried out in incremental mode.

18. A decoder for use in a speech recognition system, the decoder comprising:
a speech acoustic model;
a feature modification component; and
a comparison component,
wherein the feature modification component is configured to modify feature vectors extracted from a speech signal, using adaptation data and prior statistics, to more closely match the speech acoustic model, and wherein the comparison component is configured to utilize the modified feature vectors and the speech acoustic model to recognize the speech signal.

19. The decoder of claim 18 and wherein the feature modification component is further configured to receive prior data and to compute the prior statistics from the prior data.

20. The decoder of claim 18 and wherein the prior data comprises telephony dialogs obtained independently of the decoder, and wherein the feature modification component is configured to compute the prior statistics by:
generating feature transform matrices for the telephony dialogs; and
computing hyperparameters from the feature transform matrices.
